(19) United States
(12) Patent Application Publication
(10) Pub. No.: US 2020/0223196 A1
(43) Pub. Date: Jul. 16, 2020

(54) Carpet Compositions Having Laminated Film Backings and Methods for Making Same

(71) Applicant: Columbia Insurance Company, Omaha, NE (US)

(72) Inventors: Jeffrey Thomas Coon, Dalton, GA (US); James Andrew Fincher, Rocky Face, GA (US)

(21) Appl. No.: 16/736,135

(22) Filed: Jan. 7, 2020

Related U.S. Application Data
(60) Provisional application No. 62/789,298, filed on Jan. 7, 2019.

(51) Int. Cl. B32B 27/12; B32B 5/02; B32B 7/12; B32B 27/32; B32B 27/36; B32B 37/12; B32B 5/24; B32B 27/08; D06N 7/00

(52) U.S. Cl. CPC B32B 27/12; B32B 5/02; B32B 7/12; B32B 27/32; B32B 27/36; B32B 37/12; B32B 38/0036; B32B 27/08; D06N 7/0078; D06N 7/0089; B32B 2471/02; B32B 2307/7265; B32B 2309/02; B32B 5/24

(57) ABSTRACT

This disclosure relates to a carpet having fluid barrier properties. The disclosed carpet comprises: (a) a greige good comprising: i) a primary backing material having a face surface and a back surface; ii) a plurality of fibers attached to the primary backing material, wherein a portion of the plurality of fibers extends from the face surface of the primary backing and wherein a second portion of the plurality of fibers are exposed on the back surface of the primary backing in a form of back stitches; b) an adhesive layer comprising a hot melt adhesive composition applied to the back surface of the primary backing material, wherein the adhesive composition is configured to substantially encapsulate at least a portion of the back stitches; and c) a laminated film having fluid barrier properties. Also disclosed are methods for making the carpet described herein.

This application claims the benefit of U.S. Provisional Application No. 62/789,298, filed on Jan. 7, 2019, which is incorporated herein in its entirety.

### FIELD OF THE INVENTION

The present invention pertains to carpets and carpet products having improved fluid barrier properties and lower cost. More particularly, the present invention pertains to carpets and carpet products comprising a greige good and an adhesive layer comprising a hot melt adhesive composition. The carpets and carpet products of the present invention further comprise a laminated film behaving as a barrier impervious to fluid penetration. The present invention further pertains to methods of making such carpet or carpet products as described herein.

### BACKGROUND OF THE INVENTION

Most conventional carpets comprise a primary backing with yarn tufts in the form of cut or uncut loops extending upwardly from the backing to form a pile surface. In the case of tufted carpets, the yarn is inserted into a primary backing by tufting needles and a binder (carpet coating) is applied thereto. In the case of non-tufted or bonded pile carpets, the fibers are embedded and actually held in place by the binder composition. In both cases, the carpet construction can also include a secondary backing bonded to the primary backing. The secondary backing provides extra padding to the carpet, absorbs noise, adds dimensional stability and often functions as a thermal insulator. Similar techniques are used in both the preparation of continuous (rolled) carpets as well as carpet tiles.

The conventional coating of residential carpet comprises a wet process in which a latex compound is applied wet and then sent through an oven to evaporate the water and increase the strength of the latex applied to the carpet. This latex locks the tufts into place and also secures the secondary backing to the tufted carpet. However, such traditional methods require a large compounding and coating process as well as use of significant amounts of natural gas to heat an oven.

Hot melt coating has traditionally been too expensive due to raw material costs. In the past, this method has also had issues with getting good penetration into the yarn bundle to lock the fiber in place. However, raw material prices have become lower over the years to make this process more economically favorable. This process also became more attractive as it requires a small footprint due to not requiring an oven.

Despite the hot melts attractive properties, such as low cost and a small foot print, use of hot melts by themselves does not resolve additional challenges present in the carpet industry such as relatively low tuft bind strength and lack of the barrier properties. Accordingly, there is still a need to obtain carpets and carpet products exhibiting a high tuft bind strength, improved fluid penetration, as well as improved recyclability and low cost. Still further, there is a need to obtain carpets and carpet products that are fully recyclable. Still further, there is a need for the manufacture of such carpets or carpet products. These needs and other needs are at least partially satisfied by the present invention.

### SUMMARY OF THE INVENTION

In accordance with the purpose(s) of the invention, as embodied and broadly described herein, the invention, in one aspect, relates to a carpet comprising: (a) a greige good comprising: i) a primary backing material having a face surface and a back surface; ii) a plurality of fibers attached to the primary backing material, wherein a portion of the plurality of fibers extends from the face surface of the primary backing and wherein a second portion of the plurality of fibers are exposed on the back surface of the primary backing in a form of back stitches; b) an adhesive layer comprising a hot melt adhesive composition applied to the back surface of the primary backing material, wherein the adhesive composition is configured to substantially encapsulate at least a portion of the back stitches; and c) a laminated film having fluid barrier properties.

Also disclosed herein is a method of making a carpet comprising: (a) providing a greige good comprising: i) a primary backing material having a face surface and a back surface; and ii) a plurality of fibers attached to the primary backing material, wherein a portion of the plurality of fibers extends from the face surface of the primary backing and wherein a second portion of the plurality of fibers are exposed on the back surface of the primary backing in a form of back stitches; (b) applying a hotmelt adhesive composition to the back surface of the primary backing material to substantially encapsulate at least a portion of the back stitches and to form an adhesive layer; and (c) laminating a film to form the carpet composition having fluid barrier properties.

Additional aspects of the invention will be set forth, in part, in the detailed description, and claims which follow, and in part will be derived from the detailed description, or can be learned by practice of the invention. It is to be understood that both the foregoing general description and the following detailed description are exemplary and explanatory only and are not restrictive of the invention as disclosed.

### BRIEF DESCRIPTION OF THE DRAWINGS

FIG. 1 shows an exemplary inventive carpet structure as disclosed and described herein.

FIG. 2 shows an exemplary inventive carpet structure as disclosed and described herein.

FIG. 3 shows a schematic diagram of an exemplary film lamination process as described herein.

FIGS. 4(a) and 4(b) are photographs of exemplary carpet structures as described herein. FIG. 4(a) provides a front view of the tufted face side and the back surface with the laminated film is shown in FIG. 4(b).

FIG. 5 shows a schematic diagram of an exemplary film lamination process as described herein.

### DETAILED DESCRIPTION OF THE INVENTION

The present invention can be understood more readily by reference to the following detailed description, examples, drawings, and claims, and their previous and following description. However, before the present compositions, articles, devices, systems, and/or methods are disclosed and described, it is to be understood that this invention is not limited to the specific compositions, articles, devices, systems, and/or methods disclosed unless otherwise specified, as such can, of course, vary. It is also to be understood that the terminology used herein is for the purpose of describing particular aspects only and is not intended to be limiting.

The following description of the invention is also provided as an enabling teaching of the invention in its best, currently known aspect. To this end, those of ordinary skill in the relevant art will recognize and appreciate that changes and modifications can be made to the various aspects of the invention described herein, while still obtaining the beneficial results of the present invention. It will also be apparent that some of the desired benefits of the present invention can be obtained by selecting some of the features of the present invention without utilizing other features. Accordingly, those of ordinary skill in the relevant art will recognize that many modifications and adaptations to the present invention are possible and can even be desirable in certain circumstances and are thus also a part of the present invention. Thus, the following description is provided as illustrative of the principles of the present invention and not in limitation thereof.

Various combinations of elements of this disclosure are encompassed by this invention, e.g. combinations of elements from dependent claims that depend upon the same independent claim.

Moreover, it is to be understood that unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of aspects described in the specification.

All publications mentioned herein are incorporated herein by reference to disclose and describe the methods and/or materials in connection with which the publications are cited.

It is also to be understood that the terminology used herein is for the purpose of describing particular aspects only and is not intended to be limiting. As used in the specification and in the claims, the term “comprising” may include the aspects “consisting of” and “consisting essentially of.” Unless defined otherwise, all technical and scientific terms used herein have the same meaning as commonly understood by one of ordinary skill in the art to which this invention belongs. In this specification and in the claims which follow, reference will be made to a number of terms which shall be defined herein.

As used herein, the singular forms “a,” “an” and “the” include plural referents unless the context clearly dictates otherwise. Thus, for example, reference to a “polymer” includes aspects having two or more polymers unless the context clearly indicates otherwise.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “optional” or “optionally” mean that the subsequently described event or circumstance may or may not occur, and that the description includes instances where said event or circumstance occurs and instances where it does not.

References in the specification and concluding claims to parts by weight of a particular element or component in a composition or article, denotes the weight relationship between the element or component and any other elements or components in the composition or article for which a part by weight is expressed. Thus, in a composition or a selected portion of a composition containing 2 parts by weight of component X and 5 parts by weight component Y, X and Y are present at a weight ratio of 2:5, and are present in such ratio regardless of whether additional components are contained in the composition.

As used herein, the term “by weight,” when used in conjunction with a component, unless specially stated to the contrary is based on the total weight of the formulation or composition in which the component is included. For example, if a particular element or component in a composition or article is said to have 8% by weight, it is understood that this percentage is in relation to a total compositional percentage of 100%.

A weight percent of a component, or weight %, or wt. %, unless specifically stated to the contrary, is based on the total weight of the formulation or composition in which the component is included.

“Carpet composition” is used herein in the manner as would be recognized by one of ordinary skill in the art. The definition of carpet composition as used herein includes any known in the art carpet products. As an example, and without limitation, the term “carpet composition” includes carpet tiles, rugs, and turfs. As used herein, and unless the context clearly indicates otherwise, the term carpet composition is used to generically include broadloom carpets and area rugs. To that “broadloom carpet” means a broadloom textile flooring product manufactured for and intended to be used in roll form. As used herein, and unless the context clearly indicates otherwise, the term carpet composition is used to describe any synthetic turfs or artificial grass.

As used herein the terms “synthetic turf” or “artificial turf,” or “artificial grass” can be issued interchangeably and include any form of artificial grass or turf conventionally used, for example, in athletic playing surfaces such as football, baseball, and soccer fields, and in other applications where an alternative to natural grass is desired. These applications include at least playgrounds, residential and commercial lawns, and other landscaping, jogging paths, paintball fields, tennis courts, putting greens, dog runs, landfill covers, medians and other areas near roadways, and airport grounds near runways.

The definition of carpet composition herein does not include products that would be known to one of ordinary skill in the art as “resilient flooring.” As an example, products that fall under the category of resilient flooring include, but are not limited to, linoleum, vinyl tiles, cork tiles, rubber tiles and floor mats.

As used herein, “reclaimed carpet material” refers generally to any material obtained from a prior manufactured carpet product. The prior manufactured carpet product can be a post-consumer product, such as, for example, a post residential, a post commercial, a post-industrial carpet, or a reclaimed artificial grass. In aspects where the reclaimed carpet material comprises an artificial grass, the reclaimed artificial grass can be collected from any field, from, for example, an indoor, an outdoor, or a gym, after any amount of use. As used herein, “reclaimed synthetic turf material” refers generally to any material obtained from a prior manufactured synthetic turf product. The prior manufactured synthetic turf product can be a post use or post-consumer product recovered from a point of original installation. Alternatively, the reclaimed carpet material can be a pre-consumer product, such as manufacturing remnants or quality control failures. In the aspects where the reclaimed carpet material is the reclaimed artificial grass, the artificial grass can be also a pre-consumer product.

The term “fiber” as used herein includes fibers of extreme or indefinite length (i.e. filaments) and fibers of short length (i.e., staple fibers).

The term “yarn” as used herein refers to a continuous strand, length, or bundle of fibers. The fibers can be any type of fiber as described herein.

The term “polyamide,” as utilized herein, is defined to be any long-chain polymer in which the linking functional groups are amide (—CO—NH—) linkages. The term polyamide is further defined to include copolymers, terpolymers and the like, as well as homopolymers, and also includes blends of two or more polyamides.

The term “polyester,” as utilized herein, refers to a composition comprising a long-chain synthetic polymer composed of at least 85% by weight of an ester of a substituted aromatic carboxylic acid, including but not restricted to substituted terephthalic units, p(—R—O—CO—C₆H₄—CO—O—)ₓ and parasubstituted hydroxy-benzoate units, p(—R—O—CO—C₆H₄—O—)ₓ.

As defined herein, the term “polyolefin” refers to any class of polymers produced from a simple olefin (also called an alkene with the general formula CₙH₂ₙ) as a monomer.

As used herein, the term “copolymer” refers to a polymer formed from two or more different repeating units (monomer residues). By way of example and without limitation, a copolymer can be an alternating copolymer, a random copolymer, a block copolymer, or a graft copolymer.

The term “linear” as used to describe ethylene polymers is used herein to mean the polymer backbone of the ethylene polymer lacks measurable or demonstrable long chain branches, e.g., the polymer is substituted with an average of less than 0.01 long branch/1000 carbons.

As used herein, the term “substantially,” in, for example, the context “substantially free” refers to a composition having less than about 1% by weight, e.g., less than about 0.5% by weight, less than about 0.1% by weight, less than about 0.05% by weight, or less than about 0.01% by weight of the stated material, based on the total weight of the composition.

It is further understood that the term “substantially similar,” when used in reference to a composition, refers to at least about 60% by weight, e.g., at least about 65%, at least about 70%, at least about 75%, at least about 80%, at least about 85%, at least about 90%, at least about 91%, at least about 92%, at least about 93%, at least about 94%, at least about 95%, at least about 96%, at least about 97%, at least about 98%, at least about 99%, or about 100% by weight, based on the total weight of the composition, of a specified feature or component.

The term “homogeneous ethylene polymer” as used to describe ethylene polymers is used in the conventional sense in accordance with the original disclosure by Elston in U.S. Pat. No. 3,645,992, the disclosure of which is incorporated herein by reference. As defined herein, homogeneous ethylene polymers include both substantially linear ethylene polymers and homogeneously branched linear ethylene.

The terms “substantially linear ethylene polymer” or “SLEP,” are used interchangeably, and refer specifically to homogeneously branched ethylene polymers that have long chain branching. The term does not refer to heterogeneously or homogeneously branched ethylene polymers that have a linear polymer backbone. For substantially linear ethylene polymers, the long chain branches have the same comonomer distribution as the polymer backbone, and the long chain branches can be as long as about the same length as the length of the polymer backbone to which they are attached. The polymer backbone of substantially linear ethylene polymers is substituted with about 0.01 long chain branches/1000 carbons to about 3 long chain branches/1000 carbons, from about 0.01 long chain branches/1000 carbons to about 1 long chain branches/1000 carbons, and from about 0.05 long chain branches/1000 carbons to about 1 long chain branches/1000 carbons.

Long chain branching is defined herein as a chain length of at least 6 carbons, above which the length cannot be distinguished using ¹³C nuclear magnetic resonance spectroscopy. The presence of long chain branching can be determined in ethylene homopolymers by using ¹³C nuclear magnetic resonance (NMR) spectroscopy and is quantified using the method described by Randall (Rev. Macromol. Chem. Phys., C29, V. 2&3, p. 285-297), the disclosure of which is incorporated herein by reference.

Substantially linear ethylene polymers are homogeneously branched ethylene polymers and are disclosed in U.S. Pat. Nos. 5,272,236 and 5,278,272, the disclosures of which are incorporated herein by reference. Homogeneously branched substantially linear ethylene polymers are available from The Dow Chemical Company as AFFINITY™ polyolefin plastomers and from Dupont Dow Elastomers JV as ENGAGE™ polyolefin elastomers. Homogeneously branched substantially linear ethylene polymers can be prepared via the solution, slurry, or gas phase polymerization of ethylene and one or more optional olefin comonomers in the presence of a constrained geometry catalyst, such as the method disclosed in European Patent Application 416,815-A, the disclosure of which is incorporated herein by reference. In some aspects, a solution polymerization process is used to manufacture the substantially linear ethylene polymer used in the present invention.

The term “heterogeneously branched ethylene polymer” refers to a polymer having a distribution of branching different from and broader than the homogeneous branching ethylene/α-olefin interpolymer at similar molecular weight. In further aspects, the “heterogeneous” and “heterogeneously branched” mean that the ethylene polymer is characterized as a mixture of interpolymer molecules having various ethylene to comonomer molar ratios. Alternatively, heterogeneously branched linear ethylene polymers can be defined as having a SCBDI less than about 50% and more typically less than about 30%. HBEPs and SLEPs also differ from the class of polymers known conventionally as heterogeneously branched traditional Ziegler polymerized linear ethylene interpolymers, for example, ultra low density polyethylene (“ULDPE”), very low density polyethylene (“VLDPE”), linear low density polyethylene (“LLDPE”) medium density polyethylene (“MDPE”) or high density polyethylene (“HDPE”) made, for example, using the technique disclosed by Anderson et al. in U.S. Pat. No. 4,076,698, in that substantially linear ethylene interpolymers are homogeneously branched interpolymers. Further, in accordance with the present invention, the polymer composition does not comprise more than 20% by weight of heterogeneously branched linear ethylene polymers, as measured by the total weight of the polymer composition.

Heterogeneously branched ethylene polymers are typically characterized as having molecular weight distributions, M_{w}/Mₙ in the range of from about 3.5 to about 4.1 and, as such, are distinct from substantially linear ethylene polymers and homogeneously branched linear ethylene polymers in regards to both compositional short chain branching distribution and molecular weight distribution.

As described herein, in some aspects to determine the strength of the inventive carpet composition, the Tuft Bind Test according to ASTM D-1335 is used. The Tuft Bind Test determines the amount of force that is necessary to pull the yarn from its primary backing. It is desirable to obtain carpet compositions with highest tuft bind values possible. It is understood that the carpet composition that withstands a high amount of force lasts longer, and the original appearance is preserved due to fewer snags.

As described herein, the term “semipermeable” refers to materials that are permeable with respect to certain identified fluids and impermeable to others. For example, a material that is semipermeable to gases will allow the identified gases to permeate through the material over time but will generally not allow non-gaseous fluids to permeate, such as liquids.

As described herein, the term “impermeable” refers to materials that do not allow the identified substances to pass through it. For example, a liquid impermeable material will not allow liquids to pass through.

As described herein, in some aspects to determine the efficiency of fluid barriers, the British Spill Test is used. The British Spill Test measures the penetration of a dyed water solution through the carpet product over a 24-hour period. A specified liquid amount, for example, 100 ml of liquid, is poured from a height of one meter through a funnel onto the carpet face, where it is contained in a concentrated area for 24 hours. The carpet is then evaluated for liquid penetration through the product. In some instances, the dyed water solution utilized in the test includes but is not limited to Acid Red 40.

While aspects of the present invention can be described and claimed in a particular statutory class, such as the system statutory class, this is for convenience only and one of skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

### A. Carpets

The present invention may be understood more readily by reference to the following detailed description of various aspects of the invention and the examples included therein and to the Figures and their previous and following description. In some aspects, the invention relates to a carpet composition comprising a greige good. In still further aspects, the greige good of the current disclosure comprises: a primary backing having a face surface and a back surface; and a plurality of fibers attached to the primary backing material, wherein a portion of the plurality of fibers extends from the face surface of the primary backing and wherein a second portion of the plurality of fibers are exposed on the back surface of the primary backing in a form of back stitches. In still further aspects, the carpet composition comprises an adhesive layer comprising a hot melt adhesive composition. The hot melt adhesive composition is applied to the back surface of the primary backing material, wherein the adhesive composition is configured to substantially encapsulate at least a portion of the back stitches. In still further aspects, the carpet composition described herein comprises a laminated film having fluid barrier properties. The laminated film is laminated and adhered to the hot melt adhesive layer applied to the back surface of the primary backing.

In certain aspects, the present invention pertains to any carpet composition constructed with a primary backing component and includes tufted carpet and non-tufted carpet such as needle punched carpet. To form the tufted carpet, yarn is tufted through the primary backing component such that the longer length of each stitch extends through the face surface of the primary backing component.

In yet other aspects, the carpet composition disclosed herein can be any carpet composition known in the art. In certain aspects, the carpet composition is rug, broadloom carpet, carpet tile, artificial turf or grass. In still further aspects, the carpet composition disclosed herein is recyclable. In yet other aspects, the carpet composition is at least about 50% recyclable, at least about 60% recyclable, at least about 70% recyclable, at least about 80% recyclable, at least about 90% recyclable, or 100% recyclable. It is further understood that the carpet compositions disclosed herein can comprise any amount of recyclable material in any component. In yet other aspects, the recyclable material used in any component of the carpet composition can be recycled multiple times.

In some aspects, the adhesive layer is configured to substantially encapsulate at least a portion of the back stitches. In still further aspects, the adhesive layer is configured to substantially encapsulate all of the back stitches. In certain aspects, the laminated film is applied to the adhesive layer and is bonded to at least a portion of the back stitches of the greige good. In yet other aspects, the laminated film is bonded to the adhesive layer.

In still further aspects, the carpet compositions of the present disclosure can further comprise a resilient material inserted between the adhesive layer and the laminated film. The resilient material used herein, can comprise a scrim. In some aspects, the scrim comprises a woven or a non-woven material. In certain aspects, the non-woven material can comprise fiberglass. In yet other aspects, the non-woven material can comprise polyesters, polyamides, polyurethanes, copolymers thereof, blends thereof, and the like. In still further aspects, the scrim can also be woven from fiberglass fibers using a leno weave attachment to impart stability to the resultant carpet composition. In certain aspects, the resilient material can comprise a fiberglass, classicbac woven secondary backing or crosslay products from Volm.

### Fibers

Carpet compositions described herein comprise a plurality of fibers. In some aspects, the plurality of fibers described herein can be present in yarn. In other aspects, the plurality of fibers are present as separate fibers. In some aspects, the plurality of fibers are present in tufts of yarn. In some aspects, a portion of the plurality of the fibers are exposed at the back surface of the primary backing component. In yet other aspects, a portion of the plurality of the fibers are exposed at the back surface of the primary backing component in a form of back stitches.

In certain aspects, the plurality of fibers can comprise any thermoplastic polymer known in the art. In still further aspects, the plurality of fibers can comprise a polyamide, a polyolefin, or a polyester. In yet other aspects, the plurality of fibers can comprise a combination of polyamide, a polyolefin or a polyester.

In some aspects, the polyamide as described herein can comprise one or more of nylon 6, nylon 66, nylon 10, nylon 612, nylon 12, nylon 11, or any combination thereof. In other aspects, the polyamide as described herein is nylon 6 or nylon 66. In yet other aspects, the polyamide as described herein is nylon 6. In a yet further aspect, polyamide as described herein is nylon 66.

In some aspects, polyester as described herein comprises polyethylene terephthalate (PET) homopolymers and copolymers, polybutylene terephthalate (PBT) homopolymers and copolymers, and the like, including those that contain comonomers such as cyclohexanedimethanol, cyclohexanedicarboxylic acid, and the like. In yet other aspects, the polyester described herein can comprise polyethylene terephthalate, polypropylene terephthlate, polybutylene terephthalate, copolymers thereof, or any combination thereof.

In some aspects, the polyolefins as described herein include, but are not limited to, polyethylene, polypropylene, both homopolymer and copolymers, poly(I-butene), poly(3-methyl-1-butene), poly(4-methyl-1-pentene) and the like, as well as combinations or mixtures of two or more of the foregoing. In certain aspects, the polyolefin as described herein comprises polyethylene and copolymers thereof, a polypropylene and copolymers thereof, or a combination thereof. In other aspects, the polyolefin comprises polyethylene. In yet other aspects, the polyolefin comprises polypropylene.

In still further aspects, the polyolefin described herein can comprise a low density polyethylene (LDPE), a linear low-density polyethylene (LLDPE), ultra low density polyethylene (ULDPE), very low density polyethylene (VLDPE), medium density polyethylene (MDPE), high density polyethylene (HDPE), a grafted polyethylene, heterogeneously branched ethylene polymer (HBEP), substantially linear ethylene polymer (SLEP), polypropylene, or a combination thereof.

In certain aspects, the plurality of fibers can comprise from 0 wt % to 100 wt % of a recycled polymer, including exemplary values of about 10 wt %, about 20 wt %, about 30 wt %, about 40 wt %, about 50 wt %, about 60 wt %, about 70 wt %, about 80 wt %, about 90 wt %, about 95 wt %, and about 99 wt %. It is further understood that recycled polymer can be present in any amount between any two foregoing values.

In still further aspects, the plurality of fibers can further comprise natural fibers, acrylics, viscose, rayon, cellulose acetate, linen, silk, cotton, wool, or any combination thereof. In yet other aspects, the plurality of fibers comprises nylon, polyester, or a combination thereof.

As understood by one of ordinary skill in the art, the plurality of fibers can comprise any type or form of fibers. For example, and without limitation, the plurality of fibers can comprise staple fibers or bulked continuous filament fibers.

### Primary Backing

In still further aspects, the carpet composition described herein comprises a primary backing. In some aspects, the primary backing can be present in any amount. In the aspects, where the carpet composition is a synthetic grass, the primary backing makes up from about 1 wt % to about 25 wt %, including exemplary values of about 5 wt %, about 10 wt %, about 15 wt %, and about 20 wt % of a synthetic turf. In certain aspects, the primary backing can comprise a thermoplastic polymer. In certain aspects, the thermoplastic polymer can comprise any thermoplastic polymer known in the art. In still further aspects, the thermoplastic polymer present in the primary backing can comprise a polyamide, a polyolefin, a polyester, or a combination thereof. It is understood that the polyamide can comprise any of polyamides described above. It is further understood that the polyolefin described herein can comprise any of the polyolefins described above. In still further aspects, the polyesters present in the primary backing can comprise any of polyesters described above. In yet further aspects, the blends of polymers present in the primary backing can comprise any blends of any polymers described above.

In certain aspects, the thermoplastic polymer composition present in the primary backing can comprise from 0 wt % to 100 wt % of a recycled polymer, including exemplary values of about 10 wt %, about 20 wt %, about 30 wt %, about 40 wt %, about 50 wt %, about 60 wt %, about 70 wt %, about 80 wt %, about 90 wt %, about 95 wt %, and about 99 wt %. It is further understood that recycled polymer can be present in any amount between any two foregoing values.

In certain aspects, the primary backing component comprises a polyolefin, a polyester, a polyamide, or a combination thereof. The primary backing component can be woven and non-woven. In certain aspects, the primary backing component can comprise non-woven webs, or spunbonded materials. In some aspects, the primary backing component can comprise a combination of woven and non-woven materials. In still further aspects, the primary backing component can comprise a combination of woven and spunbonded materials. In still further aspects, the primary backing component can comprise a combination of non-woven and spunbonded materials. In still further aspects, the primary backing component can comprise a combination of woven, non-woven, and spunbonded materials. In yet other aspects, the primary backing can comprise felt. In some aspects, the primary backing component comprises a polyolefin polymer. In other aspects, the polyolefin polymer comprises polypropylene. In yet other aspects, the primary backing component is a slit film polypropylene sheet such as that sold by Propex or Synthetic Industries owned by Shaw Industries. In yet further aspects, the primary backing component can comprise polyester. In still further aspect, the primary backing component can comprise polyamide. In yet further aspects, the primary backing component can comprise a combination of polyamide and polyester. In the certain aspects, the polyamide is nylon. In some other aspects, the primary backing can comprise a woven polyethylene terephthalate (PET). In yet other aspects, the primary backing can comprise a woven PET having a post-consumer and/or post-industrial content.

In yet certain aspects, the primary backing component can be a spun-bond primary backing component. The spun bond backing can be produced by depositing extruded, spun filaments onto a collecting belt in a uniform random manner followed by bonding the fibers. The fibers are separated during the web laying process by air jets or electrostatic charges. The collecting surface is usually perforated to prevent the air stream from deflecting and carrying the fibers in an uncontrolled manner. Bonding imparts strength and integrity to the web by applying heated rolls or hot needles to partially melt the polymer and fuse the fibers together. Since molecular orientation increases the melting point, fibers that are not highly drawn can be used as thermal binding fibers. In some aspect, the spun-bond primary backing component can comprise a bi-component filament of a sheath-core type. In some aspects, the polymeric core component can have a higher melting point than the polymeric sheath component. In some aspects, the polymeric core component can comprise polyester, aliphatic polyamides, polyphenylene oxide, and/or co-polymers or blends thereof. In yet other aspects, the polyester can comprise polyethylene terephthalate, polybutylene terephthalate, or polyparaphenylene terephthalamide. In yet other aspects, the polymeric core comprises polyethylene terephthalate. In further aspects, the sheath polymer can comprise a polyamide, polyethylene, or polyester. In yet further aspects, the sheath polymer can comprise nylon. In still further aspects, the sheath-core primary backing component comprises a polyester as a core component and nylon as a sheath component. The exemplary sheath-core primary backing component can be commercially available from Bonar. In yet other aspects, a polyester non-woven primary backing can be commercially available from Freudenberg.

### Adhesive Layer

As disclosed herein, the adhesive layer comprises a hot melt adhesive composition. In some aspects, the hot melt adhesive compositions comprise substantially about 100% of thermoplastic compounds and do not require a solvent or carrier. As one of ordinary skill in the art would readily appreciate use of hot melt adhesives allows avoiding emission of hazardous air pollutants (HAPs) and volatile organic compounds (VOCs) during the manufacturing process.

In certain aspects, the hotmelt adhesive compositions as disclosed herein comprise a polyethylene, a polyester, a vinyl containing polymer, a polyurethane, or a combination thereof. In yet other aspects, the hotmelt adhesive composition comprises ethylene-vinyl acetate copolymers (EVA), styrene-isoprene-styrene copolymers (SIS), styrene-butadiene-styrene copolymers (SBS), ethylene-ethyl acrylate copolymers (EEA), ultra-low density polyethylene (ULDPE), low density polyethylene (LDPE), polypropylene, ethylene-propylene diene monomer (EPDM), polyethylene terephthalate (PET), polybutylene terephthalate (PBT), polyurethane (PUR), or any combination thereof. In yet other aspects, the hotmelt adhesive composition is selected from a group of ethylene-vinyl acetate copolymers (EVA), styrene-isoprene-styrene copolymers (SIS), styrene-butadiene-styrene copolymers (SBS), ethylene-ethyl acrylate copolymers (EEA), ultra-low density polyethylene (ULDPE), low density polyethylene (LDPE), polypropylene, ethylene-propylene diene monomer (EPDM), polyethylene terephthalate (PET), polybutylene terephthalate (PBT), polyurethane (PUR), or any combination thereof.

In still further aspects, the hotmelt adhesive composition is an amorphous polyolefin hotmelt adhesive (APO). APOs bond well to nonpolar substrates like polyethylene and polypropylene. APOs have good barrier properties, i.e. low moisture and water vapor permeability, and excellent chemical resistance against polar solvents and solutions including acids, bases, esters, and alcohols and moderate heat resistance and poor chemical resistance against nonpolar solvents like alkanes, ethers, and oils. In certain aspects, the APO comprises amorphous (atactic) propylene (APP), amorphous propylene-ethylene (APE), amorphous propylene-butylene (APB), amorphous propylene-hexylene (APH), or amorphous propylene-ethylene-butylene, or a combination thereof.

In still further aspects, the adhesive composition can include a filler. For example, some of the hotmelt compositions such as EVA can be relatively expensive to use alone, and thus attempts have been made to reduce costs by blending with high levels of relatively cheap extenders, such as fillers. It is understood that adhesive layer comprising any of the disclosed above hotmelt compositions can further comprises a filler. In certain aspects, the filler can be present in any amount from about greater than 0 wt % to less than 100 wt %. In certain aspects, the filler can be present in an amount of about 5 wt %, about 10 wt %, about 20 wt %, about 30 wt %, about 40 wt %, about 50 wt %, about 60 wt %, about 70 wt %, about 80 wt %, or about 90 wt %. In still further aspects, the filler can be present up to 50 wt %, or up to 60 wt %, or up to 70 wt %. It is understood that as fillers increase viscosity, it is important to use filled hotmelt compositions with a suitable balance of fluidity and mechanical properties to serve as an adequate polymer layer.

In certain aspects, the fillers used in the compositions comprise an inert filler material. The inert filler material may be made from carbonates such as calcium carbonate (CaCo₃), cesium carbonate (CsCo₃), strontium carbonate (SrCO₃), and magnesium carbonate (MgCO₃); sulfates such as barium sulfate (BaSO₃); oxides such as iron oxide (Fe₂O₃ or Fe₃O₄), aluminum oxide (Al₂O₃), tungsten oxide (WO₃), titanium oxide (TiO₂), silicon oxide (SiO₂), silicates, such as clay; metal salts, and the like. Additionally, the inert filler material may be a flame retardant such as, but not limited to, aluminum trihydrate (ATH) or magnesium hydroxide (MgOH) for applications where flame-retardancy is desired. It is understood that filler can be also obtained from post-consumer products, such as post-consumer glass, post-consumer carpets and/or other post-consumer recycled materials. In cases where the inert filler is made from post-consumer glass, the post-consumer glass is ground into a fine glass powder before it is added as filler. The glass cullet may be made from automotive and architectural glass, also known as plate glass, flint glass, E glass, borosilicate glass, brown glass (bottle glass), green glass (bottle glass), and coal fly ash, or a combination thereof. In aspects, where post-consumer carpet is used as the inert filler material, the post-consumer carpet maybe ground into a fine cullet and added to the hot melt adhesive. In addition to the post-consumer carpet, remnants and trimmings of carpet, fine waste fibers that are a result of the shearing process, and the like, that are produced as a by-product during the manufacturing process may also be used to form the inert filler material. The use of post-consumer products provides environmental benefits, as materials that were destined for landfills may be diverted to make new, useful products, such as carpet and carpet tiles.

It is further understood that as disclosed herein the adhesive layers can comprise both filled (with a filler) and unfilled hotmelt compositions. It is further understood that the ranges of specifications for such compositions, for example, viscosities, temperatures, and others, can be same or different for filled/unfilled hotmelt adhesive compositions.

In still further aspects, the adhesive compositions disclosed herein can comprises lubricants. In such aspects, the exemplary and non-limiting lubricant material can comprise steric acid. In aspects where the lubricant material is present, it can be present in an amount of greater than 0 wt % to about 1.5 wt % of the filled or unfilled hotmelt adhesive composition, including exemplary values of about 0.1 wt %, about 0.2 wt %, about 0.3 wt %, about 0.4 wt %, about 0.5 wt %, about 0.6 wt %, about 0.7 wt %, about 0.8 wt %, about 0.9 wt %, about 1.0 wt %, about 1.1 wt %, about 1.2 wt %, about 1.3 wt %, and about 1.4 wt %.

In still further aspects, the hotmelt adhesive compositions disclosed herein can comprise a pigment, such as carbon black or another colorant(s) to provide color and increase the opaqueness of the hot melt adhesive. In certain aspects, the pigment may be present in an amount less than or equal to about 1 wt % the filled or unfilled hot melt adhesive, including exemplary values of less than or equal to about 0.9 wt %, less than or equal to about 0.8 wt %, less than or equal to about 0.7 wt %, less than or equal to about 0.6 wt %, less than or equal to about 0.5 wt %, less than or equal to about 0.4 wt %, less than or equal to about 0.3 wt %, less than or equal to about 0.2 wt %, or less than or equal to about 0.1 wt %.

In still further aspects, the hotmelt adhesive compositions disclosed herein can comprise an antioxidant. Some suitable antioxidants include, but are not limited to 2,2′-methylene bis-(4-methyl-6-tert-butylphenol), 2,4,6-tri-tert-butylphenol, 2,6-di-tert-butyl-4-methylphenol, 4,4′-thio-bis-(6-tert-butyl-m-cresol), butylated hydroxy anisole, and butylated hydroxy toluene. In some aspects, the antioxidant can be present in the filled or unfilled hot melt adhesive in any amount suitable for a specific application. In still further aspects, the antioxidant can be present in an amount less than or equal to approximately 2 wt % of the hotmelt adhesive composition, less than or equal to about 1.8 wt % the filled or unfilled hot melt adhesive, less than or equal to about 1.5 wt %, less than or equal to about 1.3 wt %, less than or equal to about 1.0 wt %, less than or equal to about 0.8 wt %, less than or equal to about 0.5 wt %, less than or equal to about 0.3 wt %, less than or equal to about 0.1 wt %, less than or equal to about 0.08 wt %, or less than or equal to about 0.05 wt %, less than or equal to about 0.03 wt % the filled or unfilled hot melt adhesive, or less than or equal to about 0.01 wt %.

In certain aspects, the hotmelt adhesive composition can further comprise one or more flame retardant components. Exemplary flame retardants that can be incorporated into the hotmelt adhesive composition include, without limitation, organo-phosphorous flame retardants, red phosphorous magnesium hydroxide, magnesium dihydroxide, hexabromocyclododecane, bromine containing flame retardants, brominated aromatic flame retardants, melamine cyanurate, melamine polyphosphate, melamine borate, methylol and its derivatives, silicon dioxide, calcium carbonate, resourcinol bis-(diphenyl phosphate), brominated latex base, antimony trioxide, strontium borate, strontium phosphate, monomeric N-alkoxy hindered amine (NOR HAS), triazine and its derivatives, high aspect ratio talc, phosphated esters, organically modified nanoclays and nanotubes, non-organically modified nanoclays and nanotubes, ammonium polyphosphate, polyphosphoric acid, ammonium salt, friaryl phosphates, isopropylated triphenyl phosphate, phosphate esters, magnesium hydroxide, zinc borate, bentonite (alkaline activated nanoclay and nanotubes), organoclays, aluminum trihydrate (ATH), azodicarbonamide, diazenedicarboxamide, azodicarbonic acid diamide (ADC), friaryl phosphates, isopropylated triphenyl phosphate, triazine derivatives, alkaline activated organoclay and aluminum oxide. Any desired amount of flame retardant can be used in the hotmelt adhesive composition and the selection of such amount will depend on a required carpet application. Such amounts can be readily determined through no more than routine experimentation.

In still another aspect, the hotmelt adhesive composition can further comprise one or more tackifying additives. The tackifier can for example be tall oil or rosin based or, alternatively, can be an aliphatic or aliphatic aromatic hydrocarbon blend resin. As the tackifier is an optional component, the amount of tackifier can be, when present, in the range of from greater than 0 weight percent up to and even exceeding about 50 weight % of the adhesive composition. For example, in one aspect, the amount of tackifier can be in the range of from about 5 weight % to about 45 weight %. In still another aspect, the amount of tackifier can be in the range of from about 10 weight % to about 20 weight %.

In yet other aspects, the hotmelt adhesive composition can be present in any amount suitable for a given application. In yet other aspects, the hotmelt adhesive composition is applied in an amount of about 4 oz/sy to about 10 oz/sy, including exemplary values of about 5 oz/sy, about 6 oz/sy, about 7 oz/sy, about 8 oz/sy, and about 9 oz/sy. For example, and without limitation, the adhesive composition can be present in an amount from about 4 ounces/sq. yard to about 8 ounces/sq. yard, or in amount from about 5 ounces/sq. yard to about 7 ounces/sq. yard, or from about 6 ounces/sq. yard to about 10 ounces/sq. yard.

It is further understood that the hotmelt adhesive composition can be applied to the carpet compositions as an adhesive layer. In certain aspects, the carpet compositions disclosed herein comprise one adhesive layer. In other aspects, the carpet composition can comprise two or more adhesive layers. The final number of the adhesive layers can be determined by one of ordinary skill in the art depending on the desired application.

Optionally, if desired the greige good can further comprise a precoat layer applied to the back surface of the primary backing prior to application of an adhesive composition. When applied, the precoat layer is disposed between the back surface of the primary backing component and the adhesive composition. In yet other aspects, the carpet compositions as disclosed herein do not comprise a precoat layer.

### Film

In still further aspects, the carpet composition described herein comprises a laminated film. The film is laminated to the back surface of the primary backing having the adhesive layer applied thereon. To that end, the laminated film can provide a variety of added benefits. First, in some aspects, the laminated film can assists in locking the tufts into the primary backing. According to these aspects, the laminated film can provide an enhanced level of tuft bind strength relative to aspects that do not have the laminated film. In further aspects, use of the laminated film can also serve to protect laminator or other nipped rollers from becoming covered up with hot melt adhesive material and thus eliminates a need for a frequent cleaning of the rollers and improves the throughput of the process. This benefit also enables the further compression and saturation of the hot melt adhesive material into the tufted back stitches and, can again, result in an enhanced tuft bind strength. In still further aspects, the laminated film of the present invention assists in achieving a desirable tuft bind and pill/fuzz of the carpet structure. In still further aspects, the laminated film can be engineered to exhibit liquid barrier properties.

In still further aspects, the laminated film is a polymer film. In yet further aspects, the laminated film comprises an engineered film. In still further aspects, the laminated film comprises a thermoplastic polymer. In certain aspects, the laminated film comprises polymers and copolymers of polyolefins, polyurethane, polyester, polyvinylchloride, polyamide, and polyethylene vinyl acetate, and the like. In yet other aspects, the laminated film comprises polyethylene, polypropylene, polyurethane, polyester, polyvinylchloride, or any combination thereof.

In some aspects, the polyamide as described herein can comprise one or more of nylon 6, nylon 66, nylon 10, nylon 612, nylon 12, nylon 11, or any combination thereof. In other aspects, the polyamide as described herein is nylon 6 or nylon 66. In yet other aspects, the polyamide as described herein is nylon 6. In a yet further aspect, polyamide as described herein is nylon 66.

In some aspects, polyester as described herein comprises polyethylene terephthalate (PET) homopolymers and copolymers, polybutylene terephthalate (PBT) homopolymers and copolymers, and the like, including those that contain comonomers such as cyclohexanedimethanol, cyclohexanedicarboxylic acid, and the like. In yet other aspects, the polyester described herein can comprise polyethylene terephthalate, polypropylene terephthlate, polybutylene terephthalate, copolymers thereof, or any combination thereof.

In some aspects, the polyolefins as described herein include, but are not limited to, polyethylene, polypropylene, both homopolymer and copolymers, poly(I-butene), poly(3-methyl-1-butene), poly(4-methyl-1-pentene) and the like, as well as combinations or mixtures of two or more of the foregoing. In certain aspects, the polyolefin as described herein comprises polyethylene and copolymers thereof, a polypropylene and copolymers thereof, or a combination thereof. In other aspects, the polyolefin comprises polyethylene. In yet other aspects, the polyolefin comprises polypropylene.

In still further aspects, the polyolefin described herein can comprise a low density polyethylene (LDPE), a linear low-density polyethylene (LLDPE), ultra low density polyethylene (ULDPE), very low density polyethylene (VLDPE), medium density polyethylene (MDPE), high density polyethylene (HDPE), a grafted polyethylene, heterogeneously branched ethylene polymer (HBEP), substantially linear ethylene polymer (SLEP), polypropylene, or a combination thereof.

In still further aspects, the film described herein can further comprise polyvinyl butyral (PVB), acrylic based materials, ethylene acrylic acetate (EAA), ethylene vinyl acetate (EVA), ethylene methyl acrylate (EMA), or a combination thereof.

It will be understood that the film described herein can comprise any of the polymers described herein or their combination. In some aspects, any of the polymers described above can be present in an amount of greater than 0 wt % to 100 wt %. In some exemplary aspects, the film comprises a homogenous polyester present from greater than 0 wt % to 100 wt %, including exemplary values of about 5 wt %, about 10 wt %, about 20 wt %, about 30 wt %, about 40 wt %, about 50 wt %, about 60 wt %, about 70 wt %, about 80 wt %, and about 90 wt %. In still further exemplary aspects, the homogenous polyester can comprise polyethylene terephthalate, polypropylene terephthlate, or polybutylene terephthalate. In still further aspects, the homogeneous polyester can comprise polyethylene terephthalate.

In yet other exemplary aspects, the film described herein can comprise a mixture of a homogeneous polyester with a biaxially-oriented polyethylene terephthalate. In exemplary aspects, the biaxially-oriented polyethylene terephthalate is Mylar from Dupont Tejjin Films.

In still further exemplary aspects, the film can comprise a homogeneous polypropylene or homogeneous polyethylene that can be present in an amount of greater than 0 wt % to 100 wt %, including exemplary values of about 5 wt %, about 10 wt %, about 20 wt %, about 30 wt %, about 40 wt %, about 50 wt %, about 60 wt %, about 70 wt %, about 80 wt %, and about 90 wt %.

In still further aspects, the laminated film is a polyethylene. In still further aspects, the laminated film is a combination of polyethylene and polyester.

In certain aspects, the polymer film is an extruded film. In yet other aspects, the polymer film is a blown film. In a yet further aspect, the polymer film is a cast film. In a still further aspect, the polymer film is an engineered film. The term “engineered film” as used herein refers to a polymer film comprising same or different polymers and copolymers, wherein the film is formed by various techniques to ensure desirable properties. In some aspects, the engineered film is a reinforced film. In some aspects, and without limitation, the engineered reinforced film can comprise a plurality of layers of the same or different polymers or copolymers. In other aspects, the engineered film can comprise layers of polyethylene film sandwiched with a layer of polyester. In yet further aspects, the engineered film can comprise layers of polyethylene and polypropylene, or layers of polyethylene and chemically resistant ethylene vinyl alcohol (EVOH) copolymer; or layers of polyethylene and polyester. Exemplary engineered films suitable for use in the disclosed carpet structures include those commercially available from Inteplast Group.

In some aspects, the polymer film is continuous. In other aspects, the polymer film is substantially free of perforations or pinholes. In yet other aspects, the polymer film is continuous and substantially free of perforations.

In still further aspects, the polymer film is a composite film comprising polyethylene and polypropylene. In yet other aspects, the polymer film can comprise a polypropylene core. In yet other aspects, the polymer composite film can comprise at least two layers. In other aspects, the polymer composite film can comprise at least three layers. It is understood that each layer of the polymer composite film can be same or different and can comprise any of the polymers listed above. In some aspects, the composite film comprises at least three layers, and wherein each outer layer of the composite film comprises polyethylene.

In certain aspects, the laminated film can comprise from 0 wt % to 100 wt % of a recycled polymer, including exemplary values of about 10 wt %, about 20 wt %, about 30 wt %, about 40 wt %, about 50 wt %, about 60 wt %, about 70 wt %, about 80 wt %, about 90 wt %, about 95 wt %, and about 99 wt %. It is further understood that recycled polymer can be present in any amount between any two foregoing values.

In still further aspects, the laminated film described herein can have any thickness. It is understood that the thickness of the film can be determined by one of ordinary skill in the art depending on the specific application. In still further aspects, the film can have thickness from about 0.001 inch to about 0.010 inch, including exemplary values of about 0.002 inch, about 0.003 inch, about 0.004 inch, about 0.005 inch, about 0.006 inch, about 0.007 inch, about 0.008 inch, and about 0.009 inch.

In some aspects, the polymer film is a fluid barrier. In yet other aspects, the polymer film is a semipermeable material. For example, in certain aspects, the polymer film can be semipermeable to gases but not liquids. In some aspects, the polymer film is semipermeable to all atmospheric gases. In exemplary aspects and without limitation, the polymer film is semipermeable to oxygen, hydrogen, carbon dioxide, carbon oxide, nitrogen, and the like. In yet other aspects, the polymer film can be impermeable to gases. In certain aspects, the polymer film is impermeable, for example, and without limitations, to volatile organic compounds (VOCs), methane, carbon dioxide, carbon oxide, radon, gasoline, benzene and the like. In yet further aspects, the polymer film can be impermeable to the vapors.

In certain aspects, the polymer film is impermeable to fluids. For example, in some aspects the polymer film is impermeable to aqueous fluids. In still other aspects, the polymer film can be impermeable to non-aqueous fluids. In further aspects, the non-aqueous fluid can be an organic fluid. In further exemplary aspects, the polymer film can be impermeable to water, carbonated and non-carbonate beverages, juices, milk, wine, or other alcoholic beverages and substances, human or pet bodily fluids such as blood or urine, food based fluids, food processing fluids, rain, or snowmelt.

It should be appreciated that according to some aspects, a disclosed carpet composition that is liquid impermeable but that is permeable to gas and vapors can provide a carpet composition having good protection against liquid penetration while also providing for good breathability.

In an exemplary aspect, the fluid barrier protection and properties of the disclosed carpet compositions can be analyzed and exhibited pursuant to the protocols of the British Spill Test. The British Spill Test measures the penetration of a dyed water solution through a carpet product over a 24-hour period. A specified liquid amount, for example, 100 ml of liquid, is poured from a height of one meter through a funnel onto the carpet face, where it is contained in a concentrated area for 24 hours. The carpet composition is then evaluated for liquid penetration through the product. In some instances, the dyed water solution utilized in the test includes but is not limited to Acid Red 40. The disclosed carpet compositions advantageously exhibit a pass rating under the British Spill Test. To this end, according to aspects, the disclosed carpet compositions can provide a complete barrier to fluid penetration over this 24-hour testing period.

In addition to the pass rating of the British Spill Test, the disclosed carpet compositions also provide enhanced protection against wicking of spilled liquids. This enhanced protection against wicking enables ease of clean up by containing a spilled liquid in a more concentrated area and can prevent the undesired expansion of a spill. To this end, again using the protocol of the British Spill Test where a specified liquid amount, for example, 100 ml of liquid, is poured from a height of one meter through a funnel onto the carpet composition face, an initial stain area can be quantified through visual inspection of the stain. The area of this stain can then be quantified through visual inspection after a desired period of time. The desired period of time can be any duration, including for example the 24 hours utilized in the British Spill Test. Alternatively, the desired period of time can be greater or less than 24 hours, such as 5 minutes, 15 minutes, 30 minutes, 60 minutes, 1 hour, 5 hours, 10 hours, 12, hour, 18 hours, 30 hours, 36 hours, or even 48 hours.

According to aspects, the disclosed carpet compositions can exhibit enhanced wicking protection as evidenced by a substantial containment or substantial unchanged area of initial spill as described above. For example, an area of an initial spill pursuant to the British Spill Test can be visually quantified. This can be identified as spill spot or spill area at time zero or T₀. The area of the spill can then be quantified after the expiration of a defined testing period, such as 24 hours. To this end, according to aspects, the disclosed carpet compositions can exhibit a spill spot or spill area after a 24 hour period of time that is substantially contained or substantially unchanged from the initial spill spot area.

As used herein, a “substantially contained” or “substantially unchanged” spill spot or spill area can include a spill spot area that has not increased in size relative to an initial spill area over a selected testing period, such as for example 24 hours. Alternatively, this can include a spill spot area that has not increased in size relative to an initial spill area by more than about 0.5%, about 1%, about 5%, about 10%, about 25%, or about 50% over a selected testing period, such as for example 24 hours. In further aspects, the disclosed carpet compositions can exhibit wicking protection characterized by spill spot areas that do not increase by more than about 80%, about 100%, about 150%, about 200%, about 250%, about 300%, about 400%, about 500%, about 600%, about 700%, about 800%, about 900%, or even about 1000% of an original spill spot area over a selected testing period, such as for example 24 hours. As one of ordinary skill in the art will appreciate, an evaluation of wicking and any potential increase in spill spot size over a testing period can depend on the overall sample size upon which a test fluid is spilled. To that end, it should be appreciated that in some aspects, the above wicking characteristics are exhibited on sample sizes that are at least larger than the maximum spill spot size exhibited by the carpet composition over a selected testing period. Again, it should also be understood that the desired testing period can be any duration, including for example the 24 hours utilized in the British Spill Test. Alternatively, the desired period of time can be greater or less than 24 hours, such as 5 minutes, 15 minutes, 30 minutes, 60 minutes, 1 hour, 5 hours, 10 hours, 12, hour, 18 hours, 30 hours, 36 hours, or even 48 hours. In still further aspects, the enhanced wicking protection exhibited by the disclosed carpet compositions can be characterized by an initial spill spot or area that does not wick to one or more edges of a testing sample carpet after a selected testing period.

It has been found that the inventive carpet compositions comprising laminated films demonstrate exceptional strength properties. It is hypothesized that the laminated film when it is combined with the hot melt adhesive improves the carpet compositions' tuft binds by improving the penetration of the hot melt into the tufts. In yet other aspects, it is further speculated that the exceptional strengths of the disclosed carpet compositions are due to the laminated films assisting in locking the tufts into the primary backings. In some aspects, the carpet composition disclosed herein exhibits a tuft bind strength measured according to ASTM D1335 (Tuft Bind-Pile Floor Coverings and Turf Fields) of at least 3 lbf. In yet other aspects, the carpet composition exhibits a tuft bind of at least 4 lbf, at least 5 lbf, at least 6 lbf, at least 7 lbf, at least 8 lbf, at least 9 lbf, or at least 10 lbf. In yet other aspects, the carpet composition disclosed herein can exhibit a tuft bind of at least 7 lbf to about 13 p lbf, including exemplary values of about 8 lbf, about 9 lbf, about 10 lbf, about 11 lbf, and about 12 lbf. In yet other aspects, the carpet composition disclosed herein can exhibit a tuft bind strength from about 3 lbf to about 10 p lbf, including exemplary values of about 4 lbf, about 5 lbf, about 6 lbf, about 7 lbf, about 8 lbf, and about 9 lbf. In yet other aspects, the inventive carpet compositions exhibit an improved fuzz resistance when compared to the conventional carpets without laminated films on the hot melt adhesives.

In yet other aspects, the inventive carpet compositions are dimensionally stable and provide less than 0.20%, less than 0.19%, less than 0.18%, less than 0.17%, less than 0.16%, less than 0.15%, less than 0.14%, less than 0.13%, less than 0.12%, less than 0.11%, less than 0.10%, less than 0.09%, less than 0.08%, less than 0.07%, less than 0.06%, less than 0.05%, less than 0.04%, less than 0.03%, less than 0.02%, or less than 0.01% dimensional change of the carpet composition on an Aachen Test (ISO 2551).

In certain aspects, the inventive carpet compositions can optionally comprise a secondary backing. In these optional aspects, the secondary backing can comprise a woven material. In yet other optional aspects, the secondary backing can comprise a tape-tape yarn type backing, or a tape-spun yarn type backing. If present, the secondary backing can be a tape-tape yarn woven material. In some exemplary aspects, the secondary backing can comprise a polyolefin such as for example a polypropylene. In certain exemplary aspects, the material for the secondary backing material can be a conventional material, for example and without limitation, a woven polypropylene fabric sold by Propex. Such exemplary secondary backings can also comprise a material that is a leno weave with polypropylene tape running in one direction and polypropylene spun yarn running in the other. In still other aspects, the secondary backing material used with the present invention is a woven polypropylene fabric with monofilaments running in both directions. A suitable example of such a material is manufactured by Shaw Industries, Inc. under the designation Style S8880.

In further exemplary aspects, the secondary backing material can be a material known as a fiber lock weave or “FLW.” FLW is a fabric which includes fibers needle punched into it. It is contemplated that an FLW type fabric can also be used as a primary backing component, for example, in a carpet with a relatively low pile height or weight.

In some other exemplary aspects, the secondary backing can be a woven needle punched polypropylene fabric such as SoftBac® manufactured by Shaw Industries, Inc. In this exemplary aspect, this material has been enhanced by having about 1.5 ounce/sq. yard of polypropylene fibers or polyethylene terephthalate fibers needle punched onto one side of it and has a total basis weight of about 3.5 ounce/sq. yard. This needle punched fabric can be laminated so as to have the polypropylene fibers embedded within the adhesive backing layer. In still further aspects other materials can be used for the secondary backing, for example, and without limitation, if an integral pad is desired, a polyurethane foam or other cushion material can be laminated to the back side of the carpet. Such backings can be used for broadloom carpet or carpet tiles.

In still further aspects, the carpet composition does not comprises a secondary backing. In still further aspects, the carpet composition is substantially recyclable. In still further aspects, the carpet composition is recyclable.

In still further aspects, the carpet composition disclosed herein can further comprises a secondary backing. For example, the carpet composition further comprises an additional adhesive layer comprising a hot melt adhesive composition applied to the laminated film, and a secondary backing laminated to the additional adhesive layer. The hot melt adhesive composition in the additional layer is disclosed elsewhere herein. In one aspect, the secondary backing is a pad. Such an arrangement provides a carpet composition with the following layers in order from the bottom layer: 1. secondary backing, for example a pad, as disclosed herein; 2. adhesive layer comprising a hot melt adhesive composition as disclosed herein; 3. laminated film as disclosed herein; 4. adhesive layer comprising a hot melt adhesive composition as disclosed herein; and 5. a greige good as disclosed herein.

In still further aspects, the carpet composition comprises a carpet tile, an artificial turf, a rug, a broadloom carpet or any combination hereof.

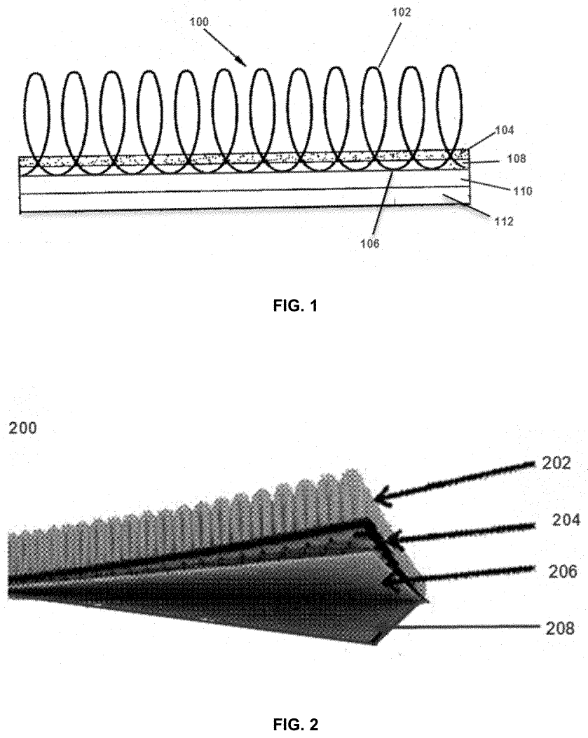

FIG. 1 schematically shows an exemplary aspect of this invention. Specifically, FIG. 1 demonstrates an exemplary carpet composition 100 disclosed herein. A plurality of fibers 102 are attached to or tufted into a primary backing component 104 and extending from a face surface of the primary backing component. A portion of the plurality of fibers is exposed at a back surface of the primary backing component in the form of back stitches 106. An exemplary adhesive layer comprising a hotmelt adhesive composition 108 is applied to the back surface of the primary backing component and the back stitches. An optional resilient material 110 is disposed between the hotmelt adhesive composition 108 and a laminated film 112.

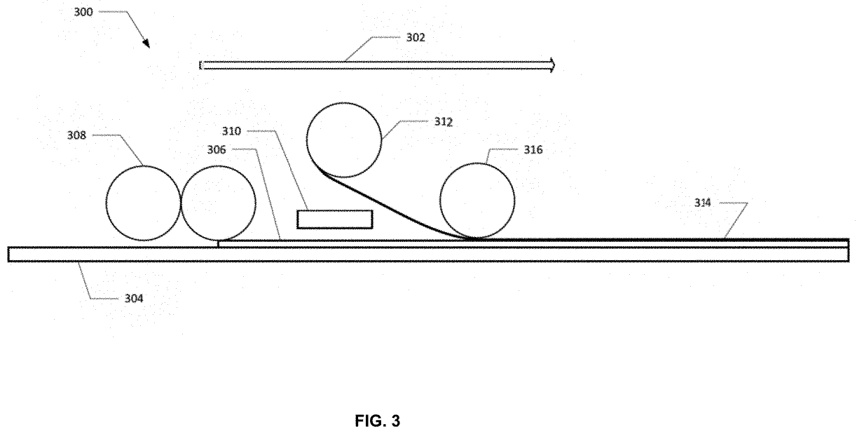

FIG. 2 shows another exemplary composition of the inventive carpet composition. Specifically, FIG. 2 demonstrates an exemplary carpet structure 200 as disclosed a described herein. A plurality of face fibers 202 present in a yarn is attached to or tufted into a primary backing component 204 and is extending from a face surface of the primary backing. A hot melt adhesive 206 is applied to the back surface of the primary backing followed by lamination of a film 208.

### B. Methods of Making Carpets

In still further aspects, disclosed herein are the methods of making inventive carpet compositions.

In certain aspects, described herein is a method of making a carpet comprising (a) providing a greige good comprising: i) a primary backing material having a face surface and a back surface and ii) a plurality of fibers attached to the primary backing material, wherein a portion of the plurality of fibers extends from the face surface of the primary backing and wherein a second portion of the plurality of fibers are exposed on the back surface of the primary backing in a form of back stitches; (b) applying a hotmelt adhesive composition to the back surface of the primary backing material to substantially encapsulate at least a portion of the back stitches and to form an adhesive layer; and (c) laminating a film to form the carpet composition having fluid barrier properties.

The face of a tufted carpet can generally be made in three ways. First, for loop pile carpet, the yarn loops formed in the tufting process are left intact. Second, for cut pile carpet, the yarn loops are cut, either during tufting or after, to produce a pile of single yarn ends instead of loops. Third, some carpet styles include both loop and cut pile. One variety of this hybrid is referred to as tip-sheared carpet where loops of differing lengths are tufted followed by shearing the carpet at a height so as to produce a mix of uncut, partially cut, and completely cut loops. Alternatively, the tufting machine can be configured so as to cut only some of the loops, thereby leaving a pattern of cut and uncut loops. Whether loop, cut, or a hybrid, the yarn on the back surface of the primary backing component comprises tight, unextended loops. The combination of tufted yarn and a primary backing component without the application of an adhesive backing material or secondary backing material is referred to in the carpet industry as raw tufted carpet or greige goods. Greige goods become finished tufted carpet with the application of an adhesive backing material and secondary backing material if present to the back surface of the primary backing component. In the aspects of the current invention, the greige goods become finished tufted carpet with the application of an adhesive backing material and the polymer film. In certain aspects of the invention, the polymer film is a fluid barrier. Finished tufted carpet can be prepared as broad-loomed carpet in rolls typically 6 or 12 feet wide.

Any conventional tufting or needle-punching apparatus and/or stitch patterns can be used to make the carpet compositions of the present invention. Likewise, it does not matter whether tufted yarn loops are left uncut to produce a loop pile; cut to make cut pile; or cut, partially cut and uncut to make a face texture known as tip sheared. After the yarn is tufted or needle-punched into the primary backing component, the greige good can be conventionally rolled up with the back surface of the primary backing component facing outward and held until it is transferred to the backing line.

In one exemplary aspect, the greige good can be scoured or washed before it has an adhesive composition applied thereon to remove or displace all or substantially all of the processing materials, such as for example oily or waxy chemicals, known as spin-finish chemicals, that remain on the yarn from the yarn manufacturing processes. It is also contemplated that the use of polyolefin waxes (rather than conventional organic and mineral oils) as processing materials would allow improved adhesive composition performance in itself or at least minimize the use of scouring or washing methodologies.

The disclosed adhesive composition can be applied to the back surface of the primary backing component to affix the yarn to the primary backing component. In one aspect, the adhesive backing substantially encapsulates a portion of the back stitching of the yarn, penetrates the yarn, and binds individual carpet fibers. Properly applied adhesive compositions do not substantially pass through the primary backing component.

In some aspects, the greige good can optionally comprise a precoat layer disposed between the back surface of the primary backing component and the adhesive composition. The precoat can be applied to the carpet in various ways. For example, the dispersion can be applied directly, such as with a roll over roller applicator, or a doctor blade. Alternatively, the precoat can be applied indirectly, such as with a pan applicator. In yet other aspects, the carpet composition of the present invention does not comprise a precoat layer.

The hotmelt adhesive compositions can be applied by any methods known in the art. In some aspects, the hotmelt adhesive composition can be applied as an extruded sheet. In other aspects, a hotmelt adhesive composition is extruded through a die so as to make a sheet which is as wide as the carpet. The molten, extruded sheet is applied to the back surface of the primary carpet backing or a precoat layer if present. Since the sheet is molten, the sheet will conform to the shape of the loops of yarn and further serve to substantially encapsulate at least a portion of the back stitches, and thus to fix the loops in the primary backing component.

In aspects where extrusion techniques are used, exemplary extrusion coating configurations can include, without limitation, a monolayer T-type die, single-lip die coextrusion coating, dual-lip die coextrusion coating, a coat hanger die, and multiple stage extrusion coating. In some aspects, the extrusion coating equipment is configured to apply a total coating weight of from about 1 to about 60 ounces/yd² (OSY), including exemplary amounts of about 2, 3, 4, 5, 7, 8, 9, 10, 15, 20, 25, 30, 35, 40, 45, 50 and about 55 ounces/yd² (OSY), and any range of coating weights derived from these values. To that end, it should be understood that the desired coating weight of the extrusion coated layers will depend, at least in part, upon the amount of any flame retardants or mineral fillers in the extrudate.

The extrusion coating melt temperature principally depends on the particular composition of the adhesive composition being extruded. When using the adhesive composition described above, comprising the disclosed substantially linear polyethylene, the extrusion coating melt temperature can be greater than about 350° F. and, in some aspects, in the range of from 350° F. to 650° F. In another aspect, the melt temperature can be in the range of from 375° F. to 600° F. Alternatively, the melt temperature can be in the range of from 400° F. to 550° F. Still further, in aspects of the invention the melt temperature can be in the range of from 425° F. to 500° F.

In still further aspects, the hotmelt adhesive composition is integrally fused with at least a portion of the back stitches.

The film of the present disclosure can be prepared by any techniques known in the art. In some aspects, the film can be extruded. In yet other aspects, the film can be blown. In yet further aspects, the film can be cast. In still further aspects, the film can be engineered to provide desirable characteristics.

The film of the inventive carpet composition can be applied to the adhesive layer by any methods known in the art. In still further aspects, the laminated film is bonded to at least a portion of the back stitches of the greige good. In still further aspects, the film is bonded to the adhesive layer.

The method of the current disclosure provides a step of laminating the film to the adhesive layer and bonding it to at least a portion of the back stitches of the greige good. In other aspects, prior to step of lamination, the carpet composition is heated. In some aspects, this step can be called a preheating step. In these aspects, the preheating of the carpet composition can be done at a temperature between about 100° F. and about 450° F., including exemplary values of about 110° F., about 120° F., about 130° F., about 140° F., about 150° F., about 160° F., about 170° F., about 180° F., about 190° F., about 200° F., about 210° F., about 220° F., about 230° F., about 240° F., about 250° F., about 260° F., about 270° F., about 280° F., about 290° F., about 300° F., about 310° F., about 320° F., about 330° F., about 340° F., about 350° F., about 360° F., about 370° F., about 380° F., about 390° F., about 400° F., about 410° F., about 420° F., about 430° F., and about 440° F. In some aspects, the lamination can be done at a temperature from about 250 to about 450° F., including exemplary values of about 260° F., about 270° F., about 280° F., about 290° F., about 300° F., about 310° F., about 320° F., about 330° F., about 340° F., about 350° F., about 360° F., about 370° F., about 380° F., about 390° F., about 400° F., about 410° F., about 420° F., about 430° F., and about 440° F.

In certain aspects, the gap between two rolls can be any gap commonly utilized by lamination industry. In certain aspects, the gap can be between about 10 mil to about 250 mils, including exemplary values of about 15 mil, about 18 mil, about 20 mil, about 30 mil, about 50 mil, about 60 mil, about 70 mil, about 80 mil, about 90 mil, about 100 mil, about 110 mil, about 120 mil, about 130 mil, about 140 mil, about 150 mil, about 160 mil, about 170 mil, about 180 mil, about 190 mil, about 200 mil, about 210 mil, about 220 mil, about 230 mil, and about 240 mil.

In still further aspects, any pressure usually used in lamination industry can be applied. In some aspects, the pressure can be between 80 psi to about 150 psi, including exemplary values of about 90 psi, about 100 psi, about 110 psi, about 120 psi, about 130 psi, and about 140 psi.

In certain aspects, the film laminated to the greige good is integrally fused with at least a portion of the back stitches, so that substantially all of the plurality of fibers are secured in place.

In still further aspects, the method disclosed herein comprises a step of inserting a resilient material between the adhesive layer and the laminated film. It is understood that such step can be accomplished by any methods known in the art and any of the resilient materials described herein can be utilized.

In still further aspects, the method disclosed herein can further comprises the steps of applying a hotmelt adhesive composition to the laminated film, and laminating a secondary backing to the laminated film.

Any known in the art lamination equipment can be used, for example a hot lamination roller. Art lamination equipment, is, for example, sold by Union Tool Corporation. An exemplary lamination equipment that can be used is a Union Tool Hot Roll Laminator MD #20962.

One skilled in the art will appreciate that, notwithstanding the particular examples described above, it is contemplated that the carpet may be produced by the processes known to those skilled in the art, including but not limited to direct coating and roll metering, and knife-coating and lick-roll application, as described in D. C. Blackly, Latex and Textiles, section 19.4.2, page 361, which is incorporated herein by reference.

FIG. 3 shows a schematic of an exemplary lamination process 300. The greige good 304 comprising a primary backing and the carpet pile are fed in a machine direction 302. A hot melt adhesive 306 is applied on the back surface of the primary backing with a hot melt applicator 308. A heat source 310 is used to dry the hot melt adhesive. A plastic film 312 is then laminated with hot lamination roller 316 on the top of hot melt adhesive to form a laminated film 314.

FIG. 5 shows a schematic of an exemplary lamination process 300 wherein a pad 318 is applied on the back surface of the back surface of the laminated film 314 via a hot adhesive melt 322. The process is similar to the one described in FIG. 3 with the addition of a hot melt spray applicator 320, which applies a hotmelt adhesive 322 onto the laminated film 314. A pad 318 is rolled onto the hotmelt adhesive 322 and the pad 318 is then then laminated with hot lamination roller 324.

### C. Experimental

The following examples are put forth so as to provide those of ordinary skill in the art with a complete disclosure and description of how the compounds, compositions, articles, devices and/or methods claimed herein are made and evaluated, and are intended to be purely exemplary of the invention and are not intended to limit the scope of what the inventors regard as their invention. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

Various carpet compositions as described herein having the hot melt adhesive layer and a laminated film layer have been constructed and evaluated for performance. The tested hot melt adhesives were purchased from various companies and included EVA based and PE based hot melt adhesives. Exemplary adhesives included EVA based adhesives such as Ateva 2830A, Ateva 1850A, Ateva 1880A, Ateva 2842A, Ateva 2850A, Reynolds 54-235, Reynolds 54-235A, Reynolds 54-234C and PE based adhesives such as Ateva 193.

Table 1 shows the exemplary hot melt adhesives and their vinyl acetate (VA) content used in the current invention.

TABLE 1
Hot melt adhesives compositions and properties.

| | | Melt | | Melt | | | | |
|---|---|---|---|---|---|---|---|---|
| | % | Index | Density | Temp | Tensile | Elong | % | Viscosity |
| Adhesive type | VA | (g/10 min) | (g/cm³) | (° F.) | (psI) | (%) | Filled | @350° F. |
| Ateva 2830A | 28 | 150 | 0.945 | 154 | 580 | 810 | 0 | 56000 |
| Ateva 192 | 0 | 220 | 0.913 | 212 | 1160 | 100 | 0 | 39000 |
| Ateva 1850A | 18 | 150 | 0.935 | 183 | 1020 | 700 | 0 | 56000 |
| Reynolds 54-235A | 28 | | 1.05 | 160 | | | 10 | 500-700 |
| Reynolds 54-2350 | 28 | | | | | | 30 | |
| Reynolds 54-235 | 28 | | | | | | 0 | |
| Ateva 1880A | 18 | 500 | 0.93 | 172 | 580 | 570 | 0 | |
| Ateva 2842A | 28 | 400 | 0.941 | 149 | 363 | 600 | 0 | |
| Ateva 2850A | 28 | 850 | 0.91 | | 290 | 350 | 0 | |

To test the performance of the carpet composition having a hot melt adhesives and a laminated film a number of the carpet composition has been constructed as shown in Table 2.

TABLE 2
Carpet Constructions and Sample Weights

| | | | | Hot Melt |
|---|---|---|---|---|
| Sample | Hot Melt | Carpet | Sample | Weight** |
| ID | Adhesive | Construction | Weight* | (oz/sq. yd) |
| 1 | Ateva-1850A | 100% PET | 39.51 | 7.52 |
| 2 | Ateva 2830A | 100% PET | 40.65 | 8.66 |
| 3 | Ateva 192 | 100% PET | 40.1 | 8.11 |
| 4 | Reynolds | 100% PET | 39.09 | 4.85 |
| | 54-235A | | | |
| 5 | Reynolds | 100% PET | 39.84 | 5.6 |
| | 54-235A2 | | | |
| 6 | Ateva 192 | Commercial | 25.93 | |
| | | (control) | | |
| 7 | Ateva 192 | commercial | 34.58 | 8.65 |
| 8 | Ateva 192A | commercial | 31.94 | 6.01 |
| 9 | Reynolds | 100% PET loop | 37.6 | 9.8 |
| | 54-235C | | | |
| 10 | Reynolds | WD cutpile | 41 | 8.7 |
| | 54-235C | | | |
| 11 | Reynolds | 100% PET loop | 33.6 | 5.8 |
| | 54-235 | | | |
| 12 | Reynolds | WD cutpile | 36.3 | 8.5 |
| | 54-235 | | | |
| 13 | Ateva 1880A | 100% PET loop | 35.9 | 8.1 |
| 14 | Ateva 1880A | WD cutpile | 38.2 | 10.4 |
| 15 | Ateva 2850A | 100% PET loop | 34.1 | 6.3 |
| 16 | Ateva 2850A | WD cutpile | 38.4 | 10.6 |
| 17 | Ateva 2842A | 100% PET loop | 36.3 | 8.5 |
| 18 | Ateva 2842A | WD cutpile | 39.2 | 11.4 |
| D | | Laminated | | |
| | | hot melt | | |

*Sample weight is a total weight of the tested sample that includes a greige good, a hot melt adhesive and a laminated film.
**Hot melt adhesive weight indicates the weight of a hot melt adhesive alone.

To test the carpet constructions, first, the hot melt adhesives have been applied according to the conditions described in Table 3. Then, an engineered film comprising polyethylene and propylene and having a thickness of 5 mil was laminated to the hot melt adhesives. Prior to the lamination the samples were preheated to a temperature of 320° F., and then the film has been laminated at a laminator temperature of 360° F., with a gap of 0.02 and line speed of 15 ft/min.

TABLE 3
Hot Melt Trials Conditions

| | | Hot Melt Applicator Setpoints | | | | |
|---|---|---|---|---|---|---|
| | | Temp ° F. | | | | |
| | | (puddle | | | Line | Application |
| Sample | Carpet | temp 25° | Coater | Doctor | Speed | weight |
| ID | construction | lower) | Gap | Gap | (ft/min) | (oz/sy) |
| 2 | 100% PET | 375 | 0.04 | 0.014 | 7 | 8.66 |
| 3 | 100% PET | 375 | 0.04 | 0.016 | 7 | 8.11 |
| 1 | 100% PET | 375 | 0.04 | 0.016 | 7 | 7.52 |
| 4 | 100% PET | 375 | 0.04 | 0.016 | 7 | 4.85 |
| 9 | 100% PET | 330 | 0.067 | 0.016 | 7.5 | 9.8 |
| | loop | | | | | |
| 10 | WD cutpile | 375^{a} | 0.067 | 0.016 | 7.5 | 8.7 |
| 11 | 100% PET | 375 | 0.067 | 0.016 | 7.5 | 5.8 |
| | loop | | | | | |
| 12 | WD cutpile | 375 | 0.067 | 0.016 | 7.5 | 8.5 |
| 13 | 100% PET | 375 | 0.067 | 0.016 | 7.5 | 8.1 |
| | loop | | | | | |
| 14 | WD cutpile | 375 | 0.067 | 0.016 | 7.5 | 10.4 |
| 15 | 100% PET | 375 | 0.067 | 0.016 | 7.5 | 6.3 |
| | loop | | | | | |
| 16 | WD cutpile | 375 | 0.067 | 0.016 | 7.5 | 10.6 |
| 17 | 100% PET | 375 | 0.067 | 0.016 | 7.5 | 8.5 |
| | loop | | | | | |
| 18 | WD cutpile | 375 | 0.067 | 0.016 | 7.5 | 11.4 |

The prepared samples having the hot melt adhesive and the laminated film were tested for a delamination strength, tuft bind strength, and a bowl test. The moisture permeability of the inventive carpet compositions has been determined according to the Bowl Penetration methods described in the United States Published Patent Application US20170205327A1 (U.S. application Ser. No. 15/408,109) that is incorporated by reference herein in its entirety. The Tuft Bind (TB) has been measured according to the ASTM D1335. The delamination strength has been measured according to ASTM D-3936. The results are shown in Table 4.

Similarly the strength of the inventive carpet compositions was measure by VELCRO® test is used. The VELCRO® test utilizes a VELCRO® tester to measure the carpet composition strength. VELCRO is a registered trademark for the well-known hook and loop fastening material. In the VELCRO® test, a two pound roller approximately three-and-a-half inches wide and one-and-a-half inches in diameter coated with VELCRO® hook material is rolled repeatedly over the loop pile carpet, for example, ten times. The carpet is then inspected for protruding fibers or fuzz. By “fuzz,” it is meant short, individual filaments (often 1-3 stitch lengths long) removed from fiber bundles. The results are rated on a scale 1 to 4, with 4 being the best results. A rating of at least 3 is preferable for Velcro® and Fuzz tests. The results are shown in Table 5.

The samples dimensional stability was evaluated according to AACHEN Test (ISO 2551). Samples have about 18×18 inch dimensions were prepared. The sample size was measured in a machine and a cross direction as prepared and after exposing the sample to various conditions. The results are shown in Tables 6 and 7.

TABLE 4
Tuft Binding Strength of various carpet compositions

| | | | | | | | Applicat. | |
|---|---|---|---|---|---|---|---|---|
| | Carpet | Bowl | | | | TB | Weight | |
| ID | Construction | Test | TB | TB | TB | avg | (oz/sy) | TB/Weight |
| 2 | 100% PET | pass | 5.176 | 5.828 | 6.089 | 5.698 | | |
| 3 | 100% PET | pass | 7.468 | 9.291 | 5.774 | 7.511 | | |
| 1 | 100% PET | pass | 4.773 | 6.792 | 7.181 | 6.249 | | |
| 4 | 100% PET | pass | 6.105 | 8.652 | 7.901 | 7.553 | | |
| 4 | 100% PET | pass | 8.105 | 9.691 | 9.766 | 9.187 | | |
| 9 | 100% PET loop | | 7.825 | 7.401 | 8.287 | 7.838 | 9.8 | 0.7998 |
| 11 | 100% PET loop | | 8.437 | 7.809 | 8.875 | 8.374 | 5.8 | 1.4437 |
| 15 | 100% PET loop | | 5.442 | 6.231 | 3.286 | 4.986 | 6.3 | 0.7915 |
| 17 | 100% PET loop | | 6.177 | 6.537 | 6.29 | 6.335 | 8.5 | 0.7453 |
| 10 | WD cutpile | | 4.064 | 6.397 | 4.454 | 4.972 | 8.7 | 0.5715 |
| 12 | WD cutpile | | 5.538 | 5.64 | 6.591 | 5.923 | 8.5 | 0.6968 |
| 14 | WD cutpile | | 6.459 | 8.279 | 6.494 | 7.077 | 10.4 | 0.6805 |
| 16 | WD cutpile | | 7.103 | 4.368 | 5.428 | 5.633 | 10.6 | 0.5314 |
| 18 | WD cutpile | | 6.897 | 10.18 | 5.995 | 7.691 | 11.4 | 0.6746 |

*TB—tuft bind strength

TABLE 5
Dimensional Properties of the Carpet Compositions

| | | | | | | Avg. | Avg. | Hot |
|---|---|---|---|---|---|---|---|---|
| | Carpet | | | Warp | Fill | Warp | Fill | Melt |
| ID | Construction | Delam. | TB | Velcro | Velcro | Fuzz | Fuzz | Appl. |
| 2 | 100% PET | 7.1 | 6.37 | 1 | 1 | 1 | 1 | 8.66 |
| 3 | 100% PET | 5.8 | 6.91 | 1 | 1 | 1 | 1 | 8.11 |
| 1 | 100% PET | 7.1 | 6.73 | 1 | 1 | 1 | 1 | 7.52 |
| 4 | 100% PET | 4.1 | 10.43 | 4 | 4 | 4 | 4 | 5.6 |
| 9 | 100% PET loop | 4.6 | 9 | 2 | 2 | 2.7 | 2.7 | 9.8 |
| 11 | 100% PET loop | 5.3 | 8.6 | 3 | 3 | 3.7 | 3.7 | 5.8 |
| 13 | 100% PET loop | 7.2 | 6.4 | 1 | 1 | 2.3 | 2.3 | 8.1 |
| 15 | 100% PET loop | 2.4 | 5.2 | 2 | 2 | 3 | 3 | 6.3 |
| 17 | 100% PET loop | 7.1 | 5.1 | 1 | 1 | 1.3 | 1.3 | 8.5 |

*TB—tuft bind strength;
Delam.—delamination strength;
Avg.—average;
Appl.—Application

TABLE 6
Dimensional Properties as measured according to Aachen Test in Machine Direction

| | | | After | After 2 h | | After 48 h |
|---|---|---|---|---|---|---|
| | Carpet | Original | 2 h @ | 0.1% solution | After 24 h | @ 21° C. |
| ID | Construction | meas. | 60° C. | @ 20° C. | @60° C. | & 65% RH |
| 2 | 100% PET | 18.0125 | 17.9975 | 17.9913 | 18.0075 | 17.995 |
| 3 | 100% PET | 17.985 | 18.02 | 18.01 | 18.0188 | 18.015 |
| 4 | 100% PET | 18.0625 | 18.0788 | 18.08 | 18.0913 | 18.0825 |
| Control | Commercial with | 18.045 | 18.0413 | 18.0375 | 18.0263 | 18.0183 |
| | latex adhesive | | | | | |
| D | Laminated hot | 18.0438 | 18.045 | 18.0475 | 18.0425 | 18.0388 |
| | melt | | | | | |

| | | % | % | % | % |
|---|---|---|---|---|---|
| Trial # | Adhesive | change | change | change | change |
| 2 | 100% PET | −0.0833 | −0.1177 | −0.0278 | −0.0972 |
| 3 | 100% PET | 0.1946 | 0.1390 | 0.1879 | 0.1668 |
| 4 | 100% PET | 0.0902 | 0.0969 | 0.1594 | 0.1107 |
| Control | Commercial with | −0.0205 | −0.0416 | −0.1036 | −0.1480 |
| | latex adhesive | | | | |
| D | Laminated hot | 0.0067 | 0.0205 | −0.0072 | −0.0277 |
| | melt | | | | |

TABLE 7
Dimensional Properties as measured according to Aachen Test in Cross Direction

| | | | | After 2 h | | After 48 h |
|---|---|---|---|---|---|---|
| | | Original | After 2 h | 0.1% solution | After 24 h | @ 21° C. |
| Trial # | Adhesive | meas. | @ 60° C. | @ 20° C. | @60° C. | & 65% RH |
| 2 | 100% PET | 17.9575 | 17.9713 | 17.9713 | 17.97 | 17.965 |
| 3 | 100% PET | 17.9763 | 18.005 | 18.005 | 17.9825 | 17.9875 |
| 4 | 100% PET | 18.0175 | 18.0325 | 18.0325 | 18.0275 | 18.0275 |
| control | Commercial with | 18.0525 | 18.0613 | 18.0613 | 18.0675 | 18.06 |
| | latex adhesive | | | | | |
| D | Laminated hot melt | 18.0713 | 18.0463 | 18.0463 | 18.0425 | 18.04 |

| | | % | % | % | % |
|---|---|---|---|---|---|
| Trial # | Adhesive | change | change | change | change |
| 2 | 100% PET | 0.0768 | −0.0345 | 0.0696 | 0.0418 |
| 3 | 100% PET | 0.1597 | 0.1597 | 0.0345 | 0.0623 |
| 4 | 100% PET | 0.0833 | 0.0627 | 0.0555 | 0.0555 |
| control | Commercial with | 0.0903 | 0.1524 | 0.1247 | 0.0831 |
| | latex adhesive | | | | |
| D | Laminated hot | 0.0139 | 0.0693 | −0.0072 | −0.0211 |
| | melt | | | | |

It was found that carpet compositions having the EVA based hot melt adhesives with a laminated film show an exceptional dimension stability with a change of less than 0.1% according to the AACHEN test.

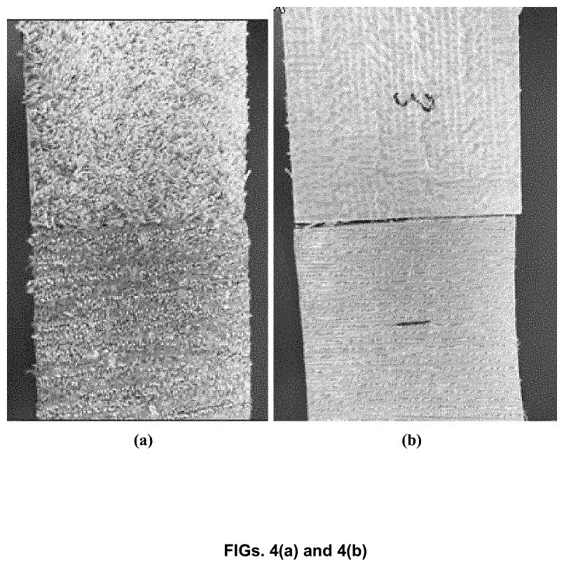

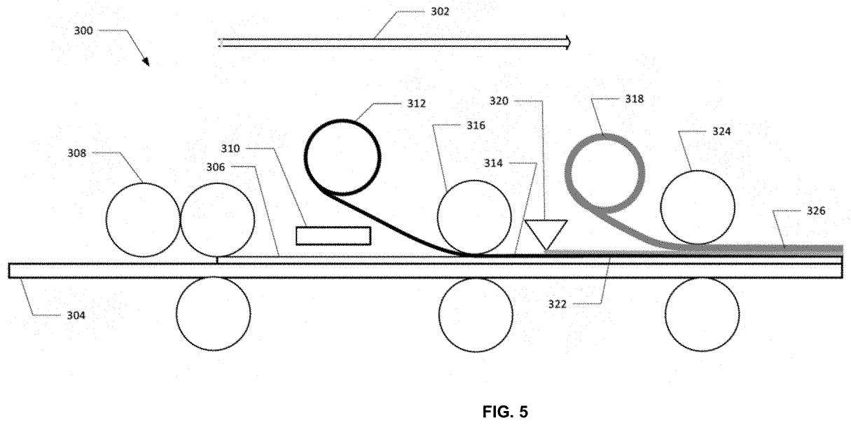

FIG. 4 shows the tuft surface (FIG. 4(a)) and the back surface of the carpet composition (FIG. 4(b)) with a laminated film.

While certain exemplary aspects of the invention have been described and disclosed, it will be apparent to those skilled in the art that various changes and modifications may be made that will achieve some or even all of the advantages of the invention without departing from the spirit and scope of the invention.

1. A carpet composition comprising:
(a) a greige good comprising:
i) a primary backing material having a face surface and a back surface;
ii) a plurality of fibers attached to the primary backing material, wherein a portion of the plurality of fibers extends from the face surface of the primary backing and wherein a second portion of the plurality of fibers are exposed on the back surface of the primary backing in a form of back stitches;
(b) an adhesive layer comprising a hot melt adhesive composition applied to the back surface of the primary backing material, wherein the adhesive composition is configured to substantially encapsulate at least a portion of the back stitches; and
(c) a laminated film having fluid barrier properties.

2. The carpet composition of claim 1, wherein the laminated film is applied to the adhesive layer and is bonded to at least a portion of the back stitches of the greige good.

3. The carpet composition of claim 1, wherein the laminated film is bonded to the adhesive layer.

4. The carpet composition of claim 1, further comprises a resilient material inserted between the adhesive layer and the laminated film.

5. (canceled)

6. (canceled)

7. The carpet composition of claim 1, wherein the hotmelt adhesive composition comprises a polyethylene, a polyester, a vinyl containing polymer, a polyurethane, or a combination thereof.

8. The carpet composition of claim 7, wherein the hotmelt adhesive composition is selected from a group of ethylene-vinyl acetate copolymers (EVA), styrene-isoprene-styrene copolymers (SIS), styrene-butadiene-styrene copolymers (SBS), ethylene-ethyl acrylate copolymers (EEA), ultra-low density polyethylene (ULDPE), low density polyethylene (LDPE), polypropylene, ethylene-propylene diene monomer (EPDM), polyethylene terephthalate (PET), polybutylene terephthalate (PBT), polyurethane (PUR), or any combination thereof.

9. The carpet composition of claim 1, wherein the hotmelt adhesive composition is applied in an amount of about 4 to about 10 oz/sy.

10. (canceled)

11. The carpet composition of claim 1, wherein the laminated film comprises polyethylene, polypropylene, polyurethane, polyester, polyvinylchloride, or any combination thereof.

12. (canceled)

13. (canceled)

14. The carpet composition of claim 1, wherein the laminated film has a thickness from about 0.001 inch to about 0.010 inch.

15. (canceled)

16. (canceled)

17. The carpet composition of claim 1, wherein the carpet composition exhibits a tuft bind strength of 3 lbf to about 10 lbf as measured according to ASTM D1335.

18.-24. (canceled)

25. The carpet composition of claim 1, wherein the carpet composition further comprises an additional adhesive layer comprising a hot melt adhesive composition applied to the laminated film, and a secondary backing laminated to the additional adhesive layer.

26. (canceled)

27. A method of making a carpet composition comprising:
(a) providing a greige good composition comprising:
i) a primary backing material having a face surface and a back surface; and
ii) a plurality of fibers attached to the primary backing material, wherein a portion of the plurality of fibers extends from the face surface of the primary backing and wherein a second portion of the plurality of fibers are exposed on the back surface of the primary backing in a form of back stitches;
(b) applying a hotmelt adhesive composition to the back surface of the primary backing material to substantially encapsulate at least a portion of the back stitches and to form an adhesive layer; and
(c) laminating a film to form the carpet composition having fluid barrier properties.

28. (canceled)

29. (canceled)

30. The method of claim 27, further comprising a step of inserting a resilient material between the adhesive layer and the laminated film.

31. The method of claim 27, wherein the hotmelt adhesive composition is integrally fused with at least a portion of the back stitches.

32. The method of claim 27, wherein the laminating is done at a temperature from about 300° F. to about 450° F.

33. The method of claim 27, wherein the carpet composition is preheated prior to the step c) to a temperature from about 150° F. to about 450° F.

34. The method of claim 27, wherein the laminated film is integrally fused with at least a portion of the back stitches, so that substantially all of the plurality of fibers are secured in place.

35. (canceled)

36. (canceled)

37. The method of claim 27, wherein the hotmelt adhesive composition comprises a polyethylene, a polyester, a vinyl containing polymer, a polyurethane, or a combination thereof.

38. (canceled)

39. The method of claim 27, wherein the hotmelt adhesive composition is applied in an amount of about 4 to about 10 oz/sy.

40. (canceled)

41. The method of claim 27, wherein the laminated film comprises polyethylene, polypropylene, polyurethane, polyester, polyvinylchloride, or any combination thereof.

42.-54. (canceled)
